(19) United States
(12) Patent Application Publication
(10) Pub. No.: US 2022/0367882 A1
(43) Pub. Date: Nov. 17, 2022

(54) SECONDARY BATTERY, ELECTRONIC DEVICE, AND POWER TOOL

(71) Applicant: MURATA MANUFACTURING CO., LTD., Kyoto (JP)

(72) Inventor: Toraji SUGENO, Kyoto (JP)

(21) Appl. No.: 17/875,956

(22) Filed: Jul. 28, 2022

Related U.S. Application Data
(63) Continuation of application No. PCT/JP2021/000829, filed on Jan. 13, 2021.

(30) Foreign Application Priority Data
Jan. 30, 2020 (JP) 2020-013748

(51) Int. Cl. H01M 4/75; H01M 10/0587; H01M 50/536; H01M 10/0525; H01M 50/533

(52) U.S. Cl. CPC H01M 4/75; H01M 10/0587; H01M 50/536; H01M 10/0525; H01M 50/533

(57) ABSTRACT

Provided is a secondary battery, in the secondary battery, the positive electrode has a covering portion covered with a positive electrode active material layer and a positive electrode active material non-covered portion on a strip-shaped positive electrode foil, a negative electrode has a covering portion covered with a negative electrode active material layer and a first negative electrode active material non-covered portion on a strip-shaped negative electrode foil, the positive electrode active material non-covered portion is joined to the positive electrode current collector plate at one end portion of the electrode winding body, the first negative electrode active material non-covered portion is joined to the negative electrode current collector plate at the other end portion of the electrode winding body, the electrode winding body has flat surface formed by bending one or both of the positive electrode active material non-covered portion and the first negative electrode active material non-covered portion.

### CROSS REFERENCE TO RELATED APPLICATIONS

The present application is a continuation of PCT/JP2021/000829, filed Jan. 13, 2021, which claims priority to Japanese patent application no. JP 2020-013748, filed Jan. 30, 2020, the entire contents of which are being incorporated herein by reference.

### BACKGROUND

The present application relates to a secondary battery, an electronic device, and a power tool.

Lithium ion batteries have been developed for applications requiring high output such as power tools and automobiles. Examples of one method for achieving high output include high rate discharge in which a relatively large current flows from a battery. In the high rate discharge, a large current flows, so that internal resistance of a battery becomes a problem.

For example, a battery is described as having high current collection efficiency in which an electrode winding body is produced by winding a positive electrode and a negative electrode while shifting a position where the positive electrode and the negative electrode overlap each other in a width direction, a current collector plate is pressed against an end portion of the electrode winding body, and the end portion and the current collector plate are joined by laser welding.

### SUMMARY

The present application relates to a secondary battery, an electronic device, and a power tool.

In the battery described above in BACKGROUND section, when the current collector plate is pressed against the end portion of the electrode winding body, there is a problem that a negative electrode active material is peeled from an active material covering portion of the negative electrode, and the peeled active material causes an internal short circuit.

Therefore, the present application relates to providing a battery for high rate discharge that does not cause an internal short circuit.

In order to solve the above-described problems, the present application provides, in an embodiment, a secondary battery in which an electrode winding body having a structure in which a strip-shaped positive electrode and a strip-shaped negative electrode are stacked with a separator interposed therebetween and wound, a positive electrode collector plate, and a negative electrode collector plate are housed in a battery can,

the positive electrode having a covering portion covered with a positive electrode active material layer and a positive electrode active material non-covered portion on a strip-shaped positive electrode foil,

the negative electrode having a covering portion covered with a negative electrode active material layer and a first negative electrode active material non-covered portion on a strip-shaped negative electrode foil,

the positive electrode active material non-covered portion being joined to the positive electrode current collector plate at one end portion of the electrode winding body,

the first negative electrode active material non-covered portion being joined to the negative electrode current collector plate at the other end portion of the electrode winding body,

the electrode winding body having a flat surface formed by bending any one or both of the positive electrode active material non-covered portion and the first negative electrode active material non-covered portion toward a central axis of the wound structure and overlapping the positive electrode active material non-covered portion and the first negative electrode active material non-covered portion, and a groove formed in the flat surface, and

the negative electrode having a second negative electrode active material non-covered portion at an end portion on a winding start side in a longitudinal direction.

According to an embodiment of the present application, it is possible to realize that the battery for high rate discharge does not cause the internal short circuit. In addition, an initial capacity can be increased. The contents of the present application should not be interpreted as being limited by the effects exemplified herein.

### BRIEF DESCRIPTION OF THE FIGURES

FIG. 1 is a sectional view of a battery according to an embodiment.

FIG. 2A is a view showing a structure before winding in which a positive electrode, a negative electrode, and a separator of Example 1 and Example 2 are stacked, and where FIG. 2B is a view showing a structure before winding in which the positive electrode, the negative electrode, and the separator of Comparative Example 1 are stacked.

FIG. 3 includes views A and B, where A is a plan view of a positive electrode current collector plate, and where B is a plan view of a negative electrode current collector plate.

FIG. 4 includes views A to F for explaining an assembly process of the battery according to an embodiment.

FIG. 5 includes views A to C, where A is a plan view and a front view of the positive electrode and the negative electrode of Example 1 before winding, where B is a sectional view of an electrode winding body on a winding start side of Example 1, and where C is a sectional view of the electrode winding body on a winding end side of Example 1.

FIG. 6 includes views A to C, where A is a plan view and a front view of the positive electrode and the negative electrode of Example 2 before winding, where B is a sectional view of the electrode winding body on the winding start side of Example 2, and where C is a sectional view of the electrode winding body on the winding end side of Example 2.

FIG. 7 includes views A to C, where A is a plan view and a front view of the positive electrode and the negative electrode of Comparative Example 1 before winding, where B is a sectional view of the electrode winding body on the winding start side of Comparative Example 1, and where C is a sectional view of the electrode winding body on the winding end side of Comparative Example 1.

FIG. 8 is a connection diagram used for describing a battery pack as an application example according to an embodiment.

FIG. 9 is a connection diagram used for describing a power tool as an application example according to an embodiment.

FIG. 10 is a connection diagram used for describing an electric vehicle as an application example according to an embodiment.

### DETAILED DESCRIPTION

Hereinafter, various embodiments of the present application will be described with reference to the drawings.

The present application will be described hereinafter, without limitation, including preferred examples.

In an embodiment, a cylindrical lithium ion battery will be described as an example of the secondary battery.

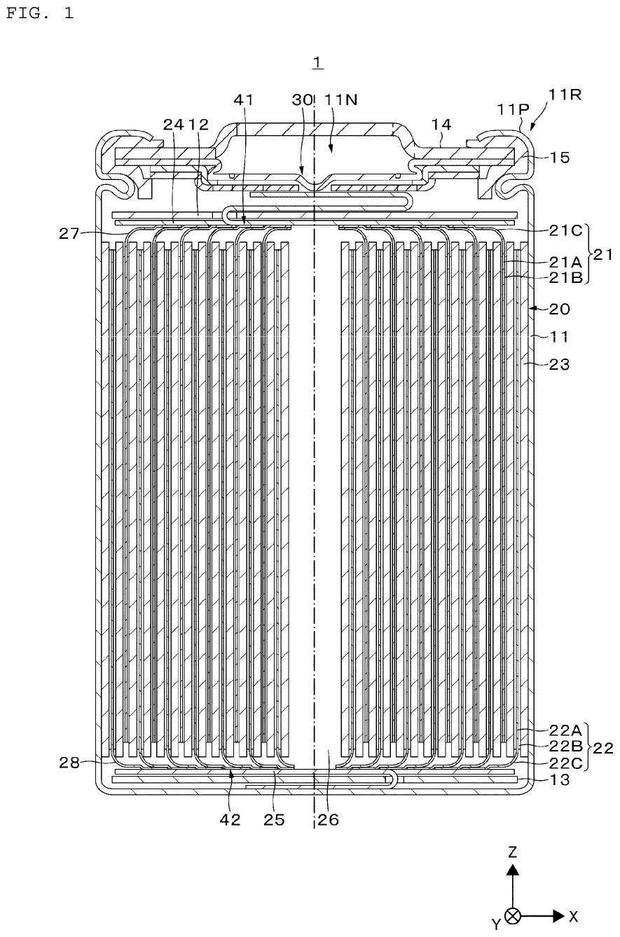

First, a whole configuration of the lithium ion battery will be described. FIG. 1 is a schematic sectional view of a lithium ion battery 1. For example, as illustrated in FIG. 1, the lithium ion battery 1 is a cylindrical lithium ion battery containing an electrode winding body 20 inside a battery can 11.

Specifically, the lithium ion battery 1 includes, for example, a pair of insulating plates 12 and 13 and the electrode winding body 20 inside the cylindrical battery can 11. However, the lithium ion battery 1 may further include, for example, one or two or more of a positive temperature coefficient (PTC) element, a reinforcing member, and the like inside the battery can 11.

The battery can 11 is a member that mainly houses the electrode winding body 20. The battery can 11 is, for example, a cylindrical vessel having one end surface opened and the other end surface closed. That is, the battery can 11 has an open end surface (open end surface 11N). The battery can 11 contains, for example, one or two or more of metal materials such as iron, aluminum and their alloys. However, one or two or more of metal materials such as nickel may be plated on the surface of the battery can 11, for example.

The insulating plates 12 and 13 are dish-shaped plates having a surface substantially perpendicular to a winding axis (Z axis in FIG. 1) of the electrode winding body 20. Furthermore, the insulating plates 12 and 13 are arranged to sandwich the electrode winding body 20 between them, for example.

At the open end surface 11N of the battery can 11, the battery lid 14 and the safety valve mechanism 30 are crimped with the gasket 15 interposed therebetween, and a crimped structure 11R (crimped structure) is formed. Consequently, the battery can 11 is hermetically sealed in a state in which the electrode winding body 20 and the like are housed inside the battery can 11.

The battery lid 14 is a member that mainly closes the open end surface 11N of the battery can 11 in the state in which the electrode winding body 20 and the like are housed inside the battery can 11. The battery lid 14 contains, for example, a material similar to a material for forming the battery can 11. A central region of the battery lid 14 protrudes, for example, in a +Z direction. Thus, a region (peripheral region) other than the central region of the battery lid 14 is in contact with, for example, the safety valve mechanism 30.

The gasket 15 is a member that mainly seals a gap between the bent portion 11P and the battery lid 14 by being interposed between the battery can 11 (bent portion 11P) and the battery lid 14. However, a surface of the gasket 15 may be coated with asphalt or the like, for example.

The gasket 15 contains, for example, one or two or more of insulating materials. The type of insulating material is not particularly limited, and is, for example, a polymeric material such as polybutylene terephthalate (PBT) and polypropylene (PP). Particularly, the insulating material is preferably polybutylene terephthalate. This is because the gap between the bent portion 11P and the battery lid 14 is sufficiently sealed while the battery can 11 and the battery lid 14 are electrically separated from each other.

When pressure (internal pressure) inside the battery can 11 rises, the safety valve mechanism 30 mainly releases the internal pressure by releasing the hermetically sealed state of the battery can 11 as necessary. The cause of the increase in the internal pressure of the battery can 11 is, for example, a gas generated due to a decomposition reaction of an electrolytic solution during charge and discharge.

In the cylindrical lithium ion battery, a strip-shaped positive electrode 21 and a strip-shaped negative electrode 22 are spirally wound with the separator 23 interposed therebetween, and are accommodated in the battery can 11 in a state of being impregnated with the electrolytic solution. The positive electrode 21 is obtained by forming a positive electrode active material layer 21B on one surface or both surfaces of a positive electrode foil 21A, and a material of the positive electrode foil 21A is, for example, a metal foil made of aluminum or an aluminum alloy. The negative electrode 22 is obtained by forming a negative electrode active material layer 22B on one surface or both surfaces of a negative electrode foil 22A, and a material of the negative electrode foil 22A is, for example, a metal foil made of nickel, a nickel alloy, copper, or a copper alloy. The separator 23 is a porous and insulating film, and enables movement of substances such as ions and an electrolytic solution while electrically insulating the positive electrode 21 and the negative electrode 22.

Each of the positive electrodes 21 has a portion in which one main surface and the other main surface of the positive electrode foil 21A are covered with the positive electrode active material layer 21B and a portion not covered with the positive electrode active material layer 21B. Each of the negative electrodes 22 has a portion in which one main surface and the other main surface of the negative electrode foil 22A are covered with the negative electrode active material layer 22B and a portion not covered with the negative electrode active material layer 22B. Hereinafter, the portions not covered with the active material layers 21B and 22B will be appropriately referred to as active material non-covered portions, and the portions covered with the active material layers 21B and 22B will be appropriately referred to as active material covered portions. In the cylindrical battery, the electrode winding body 20 is wound in such a manner that an active material non-covered portion 21C of the positive electrode and an active material non-covered portion 22C of the negative electrode are overlapped each other with the separator 23 interposed therebetween so as to face in opposite directions.

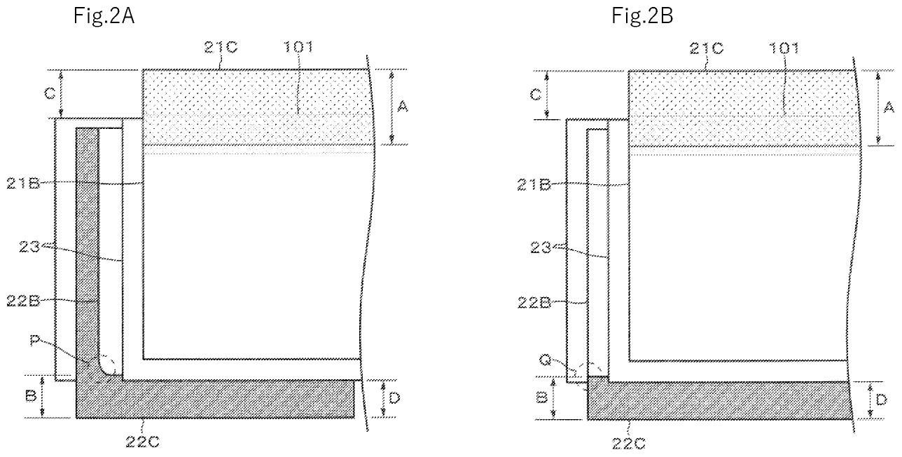

FIG. 2A shows an example of a structure before winding in which the positive electrode 21, the negative electrode 22, and the separator 23 are stacked. A width of the active material non-covered portion 21C (upper dot portion in FIG. 2) of the positive electrode is A, and a width of the active material non-covered portion 22C (lower dot portion in FIG. 2) of the negative electrode is B. In one embodiment, A>B is preferable, for example, A=7 (mm) and B=4 (mm). A length of a portion where the active material non-covered portion 21C of the positive electrode protrudes from one end of the separator 23 in the width direction is C, and a length of a portion where the active material non-covered portion 22C of the negative electrode protrudes from the other end of the separator 23 in the width direction is D. In one embodiment, C>D is preferable, for example, C=4.5 (mm) and D=3 (mm).

The negative electrode 22 has an active material covered portion 22B of the negative electrode covered with the negative electrode active material layer and the active material non-covered portion 22C of the negative electrode on a strip-shaped negative electrode foil. On one main surface of the negative electrode 22, the active material non-covered portion 22C of the negative electrode is continuously present on one long side and two short sides among four peripheries. A portion (region indicated by P) where a boundary line between the active material covered portion 22B of the negative electrode and the active material non-covered portion 22C of the negative electrode intersects has a round shape. The other main surface of the negative electrode 22 has the same structure.

FIG. 2B shows an example of the structure before winding in which the positive electrode 21, the negative electrode 22, and the separator 23 are stacked. A portion (region indicated by Q) where the boundary line between the active material covered portion 22B of the negative electrode and the active material non-covered portion 22C of the negative electrode intersects an end portion of the negative electrode 22 in a longitudinal direction is a portion where the active material of the negative electrode is most likely to be peeled off. This is because a cut surface of the active material non-covered portion 22C of the negative electrode on the boundary line is exposed.

The positive electrode foil 21A and the active material non-covered portion 21C of the positive electrode are formed from, for example, aluminum, and the negative electrode foil 22A and the active material non-covered portion 22C of the negative electrode are formed from, for example, copper and the like; therefore, in general, the active material non-covered portion 21C of the positive electrode is softer (has a lower Young's modulus) than the active material non-covered portion 22C of the negative electrode. Thus, in one embodiment, A>B and C>D are more preferable, and in this case, when the active material non-covered portion 21C of the positive electrode and the active material non-covered portion 22C of the negative electrode are simultaneously bent at the same pressure from both electrode sides, a height of the bent portion measured from a tip of the separator 23 may be substantially the same between the positive electrode 21 and the negative electrode 22. At this time, since the active material non-covered portions 21C and 22C are bent and suitably overlap each other, the active material non-covered portions 21C and 22C and current collector plates 24 and 25 can be easily joined by laser welding. Although joining in one embodiment means joining by laser welding, the joining method is not limited to laser welding.

In the positive electrode 21, a section having a width of 3 mm and including a boundary between the active material non-covered portion 21C and the active material covered portion 21B is covered with an insulating layer 101 (gray region portion in FIG. 2). The entire region of the active material non-covered portion 21C of the positive electrode facing the active material covered portion 22B of the negative electrode with the separator interposed therebetween is covered with the insulating layer 101. The insulating layer 101 has an effect of reliably preventing an internal short circuit of the battery 1 when a foreign matter enters between the active material covered portion 22B of the negative electrode and the active material non-covered portion 21C of the positive electrode. In addition, the insulating layer 101 has an effect of absorbing an impact when the impact is applied to the battery 1 and reliably preventing the active material non-covered portion 21C of the positive electrode from being bent or being short-circuited to the negative electrode 22.

A through hole 26 is formed in a central axis of the electrode winding body 20. The through hole 26 is a hole into which a winding core for assembling the electrode winding body 20 and an electrode rod for welding are inserted. Since the electrode winding body 20 is wound in an overlapping manner such that the active material non-covered portion 21C of the positive electrode and the active material non-covered portion 22C of the negative electrode face in opposite directions, the active material non-covered portion 21C of the positive electrode gathers on one end surface (end surface 41) of the electrode winding body, and the active material non-covered portion 22C of the negative electrode gathers on the other end surface (end surface 42) of the electrode winding body 20. In order to improve contact with the current collector plates 24 and 25 for extracting current, the active material non-covered portions 21C and 22C are bent, and the end surfaces 41 and 42 are flat surfaces. The bending direction is a direction from outer edge portions 27 and 28 of the end surfaces 41 and 42 toward the through hole 26, and the active material non-covered portions of adjacent peripheries overlap each other and are bent in a wound state. In the present specification, the “flat surface” includes not only an absolutely flat surface but also a surface having some unevenness and surface roughness to the extent that the active material non-covered portion and the current collector plate can be joined.

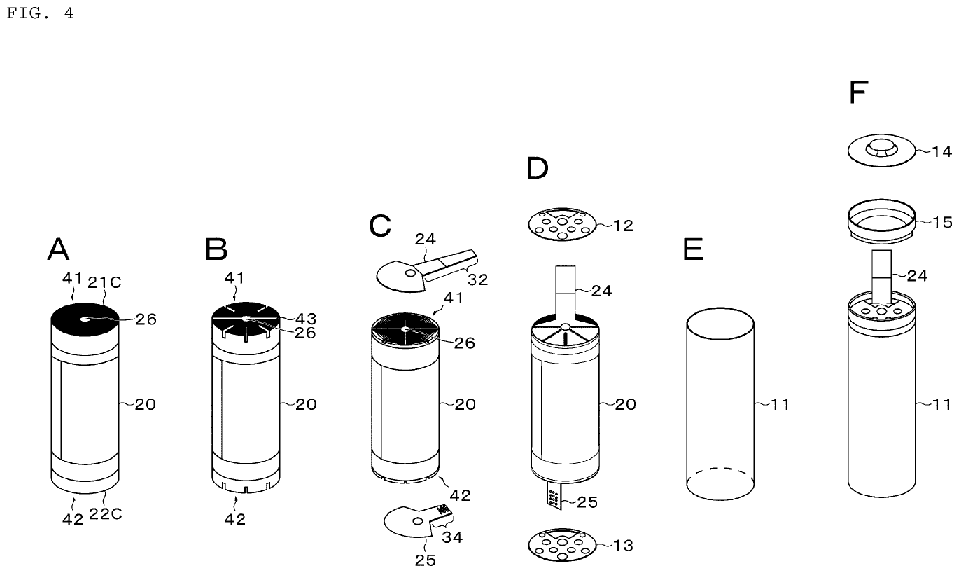

When the active material non-covered portions 21C and 22C are bent so as to overlap each other, at first it appears that the end surfaces 41 and 42 can be made flat; however, if no processing is performed before bending, wrinkles or voids (spaces) are generated in the end surfaces 41 and 42 at the time of bending, and the end surfaces 41 and 42 do not become flat surfaces. Here, “wrinkles” and “voids” are portions where unevenness occurs in the bent active material non-covered portions 21C and 22C, and the end surfaces 41 and 42 do not become flat surfaces. In order to prevent the occurrence of wrinkles and voids, a groove 43 (see, for example, FIG. 4B) is formed in advance in a radial direction from the through hole 26. The groove 43 extends from the outer edge portions 27 and 28 of the end surfaces 41 and 42 to the through hole 26. The through hole 26 is provided at the center of the electrode winding body 20, and the through hole 26 is used as a hole into which a welding tool is inserted in an assembly process of the lithium ion battery 1. The active material non-covered portions 21C and 22C at the start of winding of the positive electrode 21 and the negative electrode 22 near the through hole 26 have cut-outs. This is to prevent the through hole 26 from being closed at the time of bending toward the through hole 26. The groove 43 remains in the flat surface after the active material non-covered portions 21C and 22C are bent, and a portion without the groove 43 is joined (welded or the like) to the positive electrode current collector plate 24 or the negative electrode current collector plate 25. Not only the flat surface but also the groove 43 may be joined to a part of the current collector plates 24 and 25.

A detailed configuration of the electrode winding body 20, that is, detailed configurations of the positive electrode 21, the negative electrode 22, the separator 23, and the electrolytic solution will be described later.

In a normal lithium ion battery, for example, a lead for current extraction is welded to each one portion of the positive electrode and the negative electrode; however, this is not suitable for high rate discharge because the internal resistance of the battery is large, and the lithium ion battery generates heat and becomes high temperature during discharge. Thus, in the lithium ion battery of one embodiment, the positive electrode current collector plate 24 and the negative electrode current collector plate 25 are arranged on the end surfaces 41 and 42, and are welded to the active material non-covered portions 21C and 22C of the positive electrode and the negative electrode present on the end surfaces 41 and 42 at multiple points, thereby suppressing the internal resistance of the battery to be low. The end surfaces 41 and 42 being bent to be flat surfaces also contributes to the reduction in resistance.

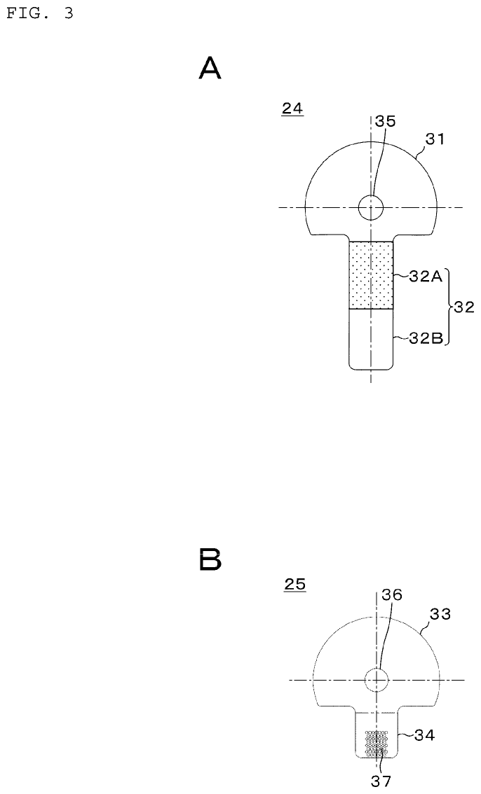

FIGS. 3A and 3B show an example of the current collector plate. FIG. 3A shows the positive electrode current collector plate 24, and FIG. 3B shows the negative electrode current collector plate 25. The material of the positive electrode current collector plate 24 is, for example, a metal plate made of a simple substance or a composite of aluminum or an aluminum alloy, and the material of the negative electrode current collector plate 25 is, for example, a metal plate made of a simple substance or a composite of nickel, a nickel alloy, copper, or a copper alloy. As shown in FIG. 3A, the positive electrode current collector plate 24 has a shape in which a rectangular strip-shaped portion 32 is attached to flat fan-shaped portion 31. A hole 35 is formed near the center of the fan-shaped portion 31, and the position of the hole 35 is a position corresponding to the through hole 26.

A portion indicated by dots in FIG. 3A is an insulating portion 32A in which an insulating tape is attached to the strip-shaped portion 32 or an insulating material is applied, and a portion below the dot portion in the drawing is a connecting portion 32B to a sealing plate also serving as an external terminal. In the case of a battery structure in which a metal center pin (not shown) is not provided in the through hole 26, there is a low possibility that the strip-shaped portion 32 comes into contact with a portion having a negative electrode potential, and therefore, the insulating portion 32A may not be provided. In this case, a width between the positive electrode 21 and the negative electrode 22 can be increased by an amount corresponding to a thickness of the insulating portion 32A to increase a charge/discharge capacity.

The negative electrode current collector plate 25 has substantially the same shape as the positive electrode current collector plate 24, but has a different strip-shaped portion. The strip-shaped portion 34 of the negative electrode current collector plate in FIG. 3B is shorter than the strip-shaped portion 32 of the positive electrode current collector plate, and has no portion corresponding to the insulating portion 32A. The strip-shaped portion 34 includes a circular protrusion (projection) 37 indicated by a plurality of circles. During resistance welding, current is concentrated on the protrusion, and the protrusion is melted to weld the strip-shaped portion 34 to a bottom of the battery can 11. Similarly to the positive electrode current collector plate 24, in the negative electrode current collector plate 25, a hole 36 is formed near the center of the fan-shaped portion 33, and the position of the hole 36 is a position corresponding to the through hole 26. The fan-shaped portion 31 of the positive electrode current collector plate 24 and the fan-shaped portion 33 of the negative electrode current collector plate 25 have a fan shape, and thus cover a part of the end surfaces 41 and 42. The reason for not covering the whole is to allow the electrolytic solution to smoothly permeate the electrode winding body when the battery is assembled, or to easily release gas generated when the battery is in an abnormally high temperature state or an overcharged state to the outside of the battery.

The positive electrode active material layer contains at least a positive electrode material (positive electrode active material) capable of occluding and releasing lithium, and may further contain a positive electrode binder, a positive electrode conductive agent, and the like. The positive electrode material is preferably a lithium-containing composite oxide or a lithium-containing phosphate compound. The lithium-containing composite oxide has, for example, a layered rock salt-type or spinel-type crystal structure. The lithium-containing phosphate compound has, for example, an olivine type crystal structure.

The positive electrode binder contains synthetic rubber or a polymer compound. The synthetic rubber includes styrene-butadiene-based rubber, fluororubber, ethylene propylene diene, and the like. The polymer compounds include polyvinylidene fluoride (PVdF), polyimide, and the like.

The positive electrode conductive agent is a carbon material such as graphite, carbon black, acetylene black, or Ketjen black. However, the positive electrode conductive agent may be a metal material and a conductive polymer.

A surface of the negative electrode current collector is preferably roughened for improving close-contact characteristics with the negative electrode active material layer. The negative electrode active material layer contains at least a negative electrode material (negative electrode active material) capable of occluding and releasing lithium, and may further contain a negative electrode binder, a negative electrode conductive agent, and the like.

The negative electrode material contains, for example, a carbon material. The carbon material is easily graphitizable carbon, non-graphitizable carbon, graphite, low crystalline carbon, or amorphous carbon. The shape of the carbon material is fibrous, spherical, granular, or scaly.

The negative electrode material contains, for example, a metal-based material. Examples of the metal-based material include Li (lithium), Si (silicon), Sn (tin), Al (aluminum), Zr (zinc), and Ti (titanium). The metal-based element forms a compound, a mixture, or an alloy with another element, and examples thereof include silicon oxide (SiOₓ (0<x≤2)), silicon carbide (SiC), an alloy of carbon and silicon, and lithium titanate (LTO).

In the active material covered portion 22B of the negative electrode, as shown by the following production method, when an end of a thin flat plate (for example, a thickness of 0.5 mm) or the like is perpendicularly pressed against the end surfaces 41 and 42 (when the state of FIG. 4B is set), the negative electrode active material may be peeled off from the active material covered portion 22B of the negative electrode on the winding start side of the electrode winding body 20 (end side in the longitudinal direction of the positive electrode or the negative electrode on an innermost circumference of the electrode winding body 20). This peeling is considered to be caused by stress generated at the time of pressing against the end surface 42. Therefore, for example, when the active material non-covered portion 22C of the negative electrode is provided on the end surface 42 side of the negative electrode on the winding start side, peeling of the negative electrode active material from the active material covered portion 22B of the negative electrode can be prevented. The negative electrode may further have the active material non-covered portion 22C of the negative electrode at an end on a winding end side in the longitudinal direction (end side in the longitudinal direction of the positive electrode 21 or the negative electrode 22 on an outermost periphery of the electrode winding body 20).

On the winding end side of the electrode winding body 20, the negative electrode 22 may have a region of the active material non-covered portion 22C of the negative electrode on a main surface on a side not facing the active material covered portion 21B of the positive electrode. This is because if the active material covered portion 22B of the negative electrode is provided on the main surface not facing the active material covered portion 21B of the positive electrode, it is considered that contribution to charging and discharging is low. The region of the active material non-covered portion 22C of the negative electrode is preferably three-quarters or more of the circumference and five-quarters or less of the circumference of the electrode winding body. At this time, since the active material covered portion 22B of the negative electrode having a low contribution to charging and discharging is not provided, an initial capacity can be increased with respect to a volume of the same electrode winding body 20.

The separator 23 is a porous film containing a resin, and may be a stacked film of two or more kinds of porous films. Examples of the resin include polypropylene and polyethylene. The separator 23 may include a resin layer on one side or both sides of a porous membrane as a substrate layer. The reason for this is that, this allows for an improvement in close-contact characteristics of the separator 23 with respect to each of the positive electrode 21 and the negative electrode 22, thereby suppressing distortion of the electrode winding body 20.

The resin layer contains a resin such as PVdF. When the resin layer is formed, the base material layer is coated with a solution prepared by dissolving the resin in an organic solvent, and thereafter, the substrate layer is dried. Alternatively, the base material layer may be immersed in the solution, and thereafter the substrate layer may be dried. The resin layer preferably contains inorganic particles or organic particles from the viewpoint of improving heat resistance and safety of the battery. The type of the inorganic particles is aluminum oxide, aluminum nitride, aluminum hydroxide, magnesium hydroxide, boehmite, talc, silica, mica, or the like. In place of the resin layer, a surface layer formed by a sputtering method, an ALD (atomic layer deposition) method, and other methods and mainly composed of inorganic particles may be used.

The electrolytic solution contains a solvent and an electrolyte salt, and may further contain an additive and the like as necessary. The solvent is a non-aqueous solvent such as an organic solvent, or water. An electrolytic solution containing a non-aqueous solvent is referred to as a non-aqueous electrolytic solution. The non-aqueous solvent is a cyclic carbonate ester, a chain carbonate ester, lactone, a chain carboxylic ester, or nitrile (mononitrile).

Although a representative example of the electrolyte salt is a lithium salt, a salt other than the lithium salt may be contained. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may be used in mixture, and among them, it is preferable to use LiPF₆ and LiBF₄ in mixture from the viewpoint of improving battery characteristics. The content of the electrolyte salt is not particularly limited, and is preferably from 0.3 mol/kg to 3 mol/kg with respect to the solvent.

A method for producing the lithium ion battery 1 of one embodiment will be described with reference to FIGS. 4A to 4F. First, the positive electrode active material was applied and attached to a surface of the strip-shaped positive electrode foil 21A to form a covered portion of the positive electrode 21, and the negative electrode active material was applied to a surface of the strip-shaped negative electrode foil 22A to form a covered portion of the negative electrode 22. At this time, the active material non-covered portions 21C and 22C not applied and attached with the positive electrode active material and the negative electrode active material were produced at one end in a transverse direction of the positive electrode 21 and one end in a transverse direction of the negative electrode 22. A cut-out was formed in a part of the active material non-covered portions 21C and 22C, the part corresponding to the winding start at the time of winding. Steps such as drying were performed on the positive electrode 21 and the negative electrode 22. The active material non-covered portion 21C of the positive electrode and the active material non-covered portion 22C of the negative electrode were overlapped with the separator 23 interposed therebetween so as to be in opposite directions, and wound in a spiral shape so as to form the through hole 26 in the central axis and to dispose the formed cut-out near the central axis, thereby producing the electrode winding body 20 as shown in FIG. 4A.

Next, as shown in FIG. 4B, by perpendicularly pressing an end of a thin flat plate (for example, a thickness of 0.5 mm) or the like against the end surfaces 41 and 42, the end surfaces 41 and 42 were locally bent to produce the groove 43. In this way, the groove 43 extending radially from the through hole 26 toward the central axis was produced. The number and arrangement of the grooves 43 shown in FIG. 4B are merely examples. As shown in FIG. 4C, the same pressure was simultaneously applied from both electrode sides in a direction substantially perpendicular to the end surfaces 41 and 42, and the active material non-covered portion 21C of the positive electrode and the active material non-covered portion 22C of the negative electrode were bent to form the end surfaces 41 and 42 to be flat surfaces. At this time, a load was applied with a flat plate surface or the like such that the active material non-covered portions on the end surfaces 41 and 42 were bent by overlapping toward the through hole 26 side. Thereafter, the fan-shaped portion 31 of the positive electrode current collector plate 24 was laser-welded to the end surface 41, and the fan-shaped portion 33 of the negative electrode current collector plate 25 was laser-welded to the end surface 42.

Thereafter, as shown in FIG. 4D, the strip-shaped portions 32 and 34 of the current collector plates 24 and 25 were bent, the insulating plates 12 and 13 (or insulating tapes) were attached to the positive electrode current collector plate 24 and the negative electrode current collector plate 25, and the electrode winding body 20 assembled as described above was inserted into the battery can 11 shown in FIG. 4E to weld the bottom of the battery can 11. After the electrolytic solution was injected into the battery can 11, sealing was performed with the gasket 15 and the battery lid 14 as shown in FIG. 4F.

### EXAMPLES

Hereinafter, the present application, in an embodiment, will be described based on Examples in which the internal short-circuit rate and the initial capacity are compared using the lithium ion battery 1 produced as described above. The present application is not limited to Examples described below.

In all of the following Examples and Comparative Examples, the battery size was 21700 (diameter: 21 mm, height: 70 mm), the width of the active material covered portion 21B of the positive electrode was 59 mm, the width of the active material covered portion 22B of the negative electrode was 62 mm, and the width of the separator 23 was 64 mm. The separator 23 was overlapped so as to cover the entire range of the active material covered portion 21B of the positive electrode and the active material covered portion 22B of the negative electrode, the width of the active material non-covered portion of the positive electrode was 7 mm, and the width of the active material non-covered portion of the negative electrode (the width of the first negative electrode active material non-covered portion) was 4 mm. In Example 1, Example 2, and Comparative Example 1, the number of the grooves 43 was eight, and the grooves were arranged at substantially equal angular intervals.

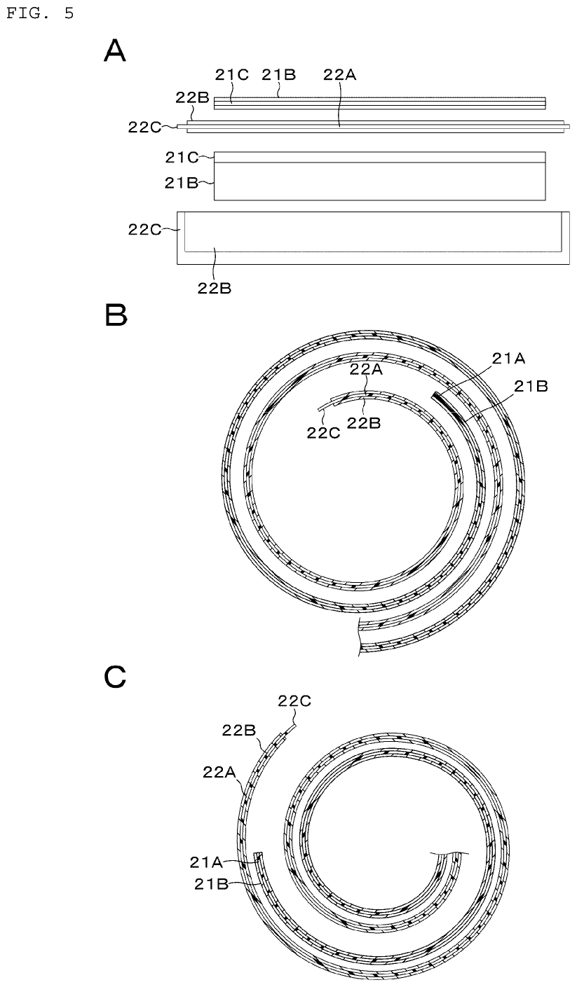

FIGS. 5B to 7B are sectional views (sectional views taken along a plane perpendicular to the winding axis) on the winding start side of the electrode winding body housed in the produced battery (state of FIG. 1), FIGS. 5C to 7C are sectional views (sectional views taken along a plane perpendicular to the Z axis of FIG. 1) on the winding end side of the electrode winding body housed in the produced battery (state of FIG. 1), and in all of the drawings, the positive electrode and the negative electrode are simply shown, and other details such as the separator are not shown.

Hereinafter, the length from an end on the winding start side or the length from an end on the winding end side of the active material non-covered portion 21C of the positive electrode at both ends in the longitudinal direction of the positive electrode 21 is appropriately referred to as a blank length, and the length from an end on the winding start side (length of a second negative electrode active material non-covered portion) or the length from an end on the winding end side (length of a third negative electrode active material non-covered portion) of the active material non-covered portion 22C of the negative electrode at both ends in the longitudinal direction of the negative electrode 22 is appropriately referred to as the blank length.

### Example 1

The length in the longitudinal direction of the active material covered portion 21B of the positive electrode was 1650 mm on both main surfaces, and the length in the longitudinal direction of the active material covered portion 22B of the negative electrode was 1703 mm for one main surface (referred to as the surface A) and 1701 mm for the other main surface (referred to as the surface B). As shown in FIG. 2A and FIG. 5A, the active material non-covered portions 22C of the negative electrode were produced at both ends in the longitudinal direction of the negative electrode 22. The blank length of the surface A of the negative electrode 22 was set to 1 mm on both the winding start side and the winding end side. The blank length of the surface B of the negative electrode 22 was set to 2 mm on both the winding start side and the winding end side. At both ends in the longitudinal direction of the positive electrode 21, the active material non-covered portion 21C of the positive electrode was not produced on both main surfaces. The blank lengths of both main surfaces of the positive electrode 21 were set to 0 mm on both the winding start side and the winding end side. With respect to the winding start side of the electrode winding body 20, as shown in FIG. 5B, the positive electrode 21 and the negative electrode 22 were arranged such that the active material covered portion 21B of the positive electrode facing the active material covered portion 22B of the negative electrode was within the range of the active material covered portion 22B of the negative electrode. Similarly on the winding end side of the electrode winding body 20, as shown in FIG. 5C, the positive electrode 21 and the negative electrode 22 were arranged such that the active material covered portion 21B of the positive electrode facing the active material covered portion 22B of the negative electrode was within the range of the active material covered portion 22B of the negative electrode.

### Example 2

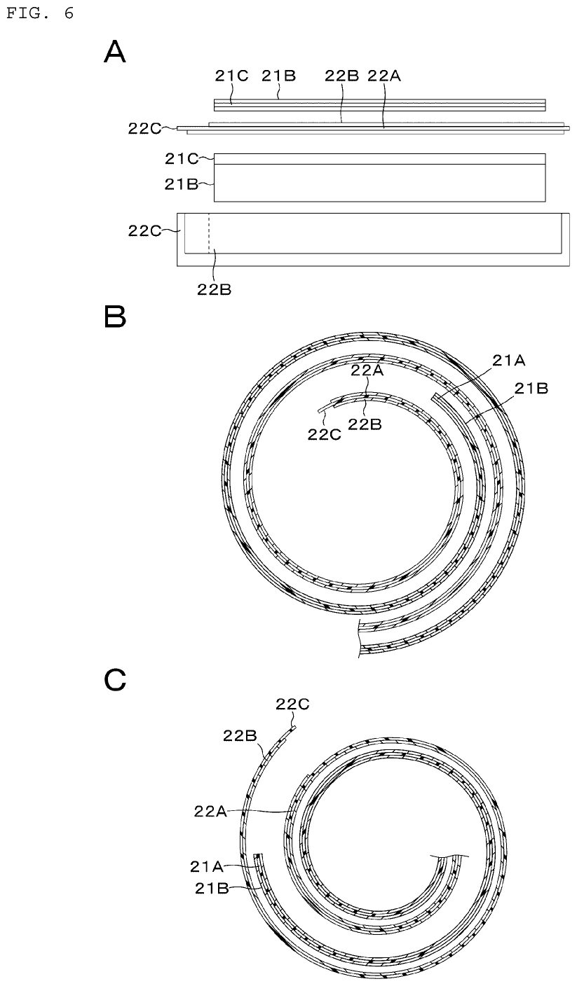

The length in the longitudinal direction of the active material covered portion 21B of the positive electrode was 1675 mm on both main surfaces, and the length in the longitudinal direction of the active material covered portion 22B of the negative electrode was 1726 mm for one main surface (referred to as the surface A) and 1662 mm for the other main surface (referred to as the surface B). As shown in FIG. 2A and FIG. 6A, the active material non-covered portions 22C of the negative electrode were produced at both ends in the longitudinal direction of the negative electrode 22. The blank length of the surface A of the negative electrode 22 was set to 1 mm on both the winding start side and the winding end side. The blank length of the surface B of the negative electrode 22 was set to 2 mm on the winding start side and 64 mm on the winding end side. At both ends in the longitudinal direction of the positive electrode 21, the active material non-covered portion 21C of the positive electrode was not produced on both main surfaces. The blank lengths of both main surfaces of the positive electrode 21 were set to 0 mm on both the winding start side and the winding end side. With respect to the winding start side of the electrode winding body 20, as shown in FIG. 6B, the positive electrode 21 and the negative electrode 22 were arranged such that the active material covered portion 21B of the positive electrode facing the active material covered portion 22B of the negative electrode was within the range of the active material covered portion 22B of the negative electrode. Similarly on the winding end side of the electrode winding body 20, as shown in FIG. 6C, the positive electrode 21 and the negative electrode 22 were arranged such that the active material covered portion 21B of the positive electrode facing the active material covered portion 22B of the negative electrode was within the range of the active material covered portion 22B of the negative electrode. As shown in FIG. 6C, a region of about one turn on the outer surface side (surface B) of the negative electrode 22 on the winding end side does not face the positive electrode 21. A region having the active material covered portion 22B of the negative electrode only on the inner surface side (surface A) of the negative electrode 22 is provided on the winding end side. In this region, if the negative electrode active material covered portion 22B is formed, a charge-discharge reaction cannot be performed. In Example 2, by providing this region of about one turn, the length of the positive electrode active material covered portion 21B could be made larger than that in Example 1. The length of this region is preferably three-quarters or more of the circumference and five-quarters or less of the circumference of the electrode winding body. This is because when the length exceeds this range, an unnecessary electrode region that does not contribute to a battery reaction is generated.

### Comparative Example 1

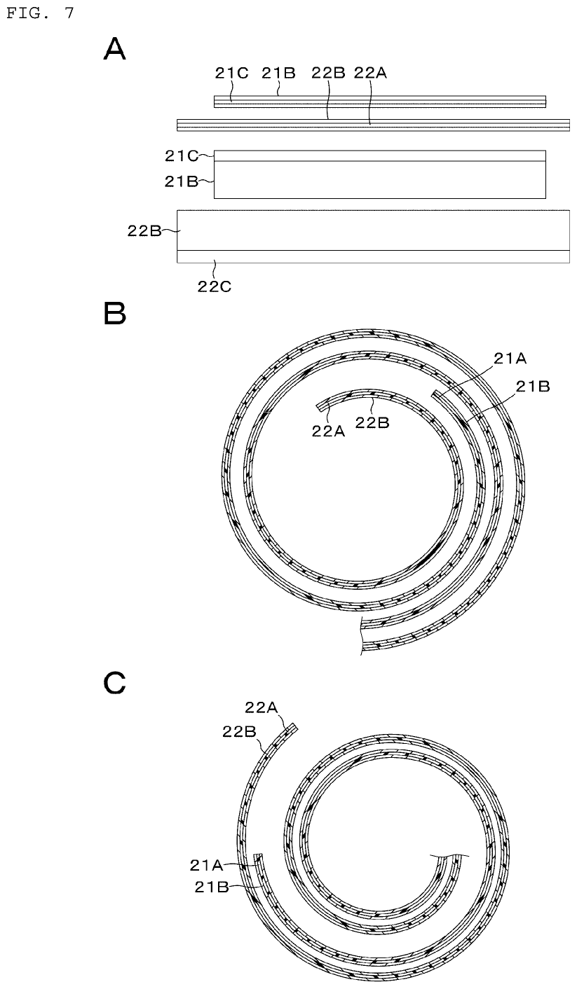

The length in the longitudinal direction of the active material covered portion 21B of the positive electrode was set to 1650 mm on both main surfaces, and the length in the longitudinal direction of the active material covered portion 22B of the negative electrode was set to 1710 mm on both main surfaces. As shown in FIG. 2B and FIG. 7A, at both ends in the longitudinal direction of the positive electrode 21, the active material non-covered portion 21C of the positive electrode was not produced on both main surfaces. The blank lengths of both main surfaces of the positive electrode 21 were set to 0 mm on both the winding start side and the winding end side. At both ends in the longitudinal direction of the negative electrode 22, the active material non-covered portion 22C of the negative electrode was not produced on both main surfaces. The blank lengths of both main surfaces of the negative electrode 22 were set to 0 mm on both the winding start side and the winding end side. As shown in FIG. 7B, the positive electrode 21 and the negative electrode 22 were arranged such that the active material covered portion 21B of the positive electrode facing the active material covered portion 22B of the negative electrode was within the range of the active material covered portion 22B of the negative electrode. Similarly on the winding end side of the electrode winding body 20, as shown in FIG. 7C, the positive electrode 21 and the negative electrode 22 were arranged such that the active material covered portion 21B of the positive electrode facing the active material covered portion 22B of the negative electrode was within the range of the active material covered portion 22B of the negative electrode.

The battery 1 of the above example was assembled and charged, and for the battery, the internal short-circuit rate and the initial capacity were obtained and evaluated. The battery 1 was assembled, charged to 4.20 V, and stored under an environment of 25±3° C. for 5 days, then the voltage of the stored battery 1 was measured, the number of batteries whose voltage decreased by 50 mV or more (voltage was 4.15 V or less) was counted, and the ratio was taken as the internal short-circuit rate. The number of batteries used in a test of the internal short-circuit rate was 100 for each example. The value of the initial capacity was 100% of the value in Example 1.

TABLE 1

| | Positive electrode | | | | Negative electrode | | | | | |
|---|---|---|---|---|---|---|---|---|---|---|
| | | | The other main | | | | The other main | | | |
| | One main surface | | surface | | One main surface | | surface | | | |
| | Length in | | Length in | | Length in | | Length in | | | |
| | longitudinal | | longitudinal | | longitudinal | | longitudinal | | | |
| | direction of | | direction of | | direction of | | direction of | | | |
| | active | | active | | active | | active | | | |
| | material | | material | | material | | material | | | |
| | covered | | covered | | covered | | covered | | | |
| | portion of | | portion of | | portion of | | portion of | | Internal | |
| | positive | Blank | positive | Blank | negative | Blank | negative | Blank | short- | Initial |
| | electrode | length | electrode | length | electrode | length | electrode | length | circuit | capacity |
| | (mm) | (mm) | (mm) | (mm) | (mm) | (mm) | (mm) | (mm) | rate (%) | (%) |
| Example 1 | 1650 | Winding | 1650 | Winding | 1703 | Winding | 1701 | Winding | 0 | 100 |
| | | start | | start | | start | | start | | |
| | | side: 0 | | side: 0 | | side: 1 | | side: 2 | | |
| | | Winding | | Winding | | Winding | | Winding | | |
| | | end side: | | end | | end | | end | | |
| | | 0 | | side: 0 | | side: 1 | | side: 2 | | |
| Example 2 | 1675 | Winding | 1675 | Winding | 1726 | Winding | 1662 | Winding | 0 | 101.5 |
| | | start | | start | | start | | start | | |
| | | side: 0 | | side: 0 | | side: 1 | | side: 2 | | |
| | | Winding | | Winding | | Winding | | Winding | | |
| | | end side: | | end | | end | | end | | |
| | | 0 | | side: 0 | | side: 1 | | side: 64 | | |
| Comparative | 1650 | Winding | 1650 | Winding | 1710 | Winding | 1710 | Winding | 6 | 100 |
| Example 1 | | start | | start | | start | | start | | |
| | | side: 0 | | side: 0 | | side: 0 | | side: 0 | | |
| | | Winding | | Winding | | Winding | | Winding | | |
| | | end side: | | end | | end | | end | | |
| | | 0 | | side: 0 | | side: 0 | | side: 0 | | |

The internal short-circuit rate of Example 1 and Example 2 was 0%, whereas the internal short-circuit rate of Comparative Example 1 was as high as 6%. It is considered that the internal short circuit occurred in the battery of Comparative Example 1 because the negative electrode active material was peeled off from the active material covered portion 22B of the negative electrode at both ends in the longitudinal direction of the negative electrode 22 when the end surface 42 was formed by bending the active material non-covered portion 22C of the negative electrode. As in Example 1 and Example 2, when there were the active material non-covered portions 22C of the negative electrode at both ends in the longitudinal direction of the negative electrode 22, the battery 1 was not internally short-circuited. The reason why no internal short circuit occurred in the batteries of Example 1 and Example 2 was considered to be that the negative electrode active material was less likely to be peeled off since there were the active material non-covered portions 22C of the negative electrode at both ends in the longitudinal direction of the negative electrode 22. From the results in Table 1, it has been found that when the active material non-covered portion 22C of the negative electrode was provided at the end on the winding start side in the longitudinal direction of the negative electrode 22 and, in addition, the active material non-covered portion 22C of the negative electrode was provided at the end on the winding end side in the longitudinal direction, the battery 1 does not cause the internal short circuit.

Although the battery can 11 having the same size was used in the battery of Example 1 and the battery of Example 2, the initial capacity of the battery of Example 2 was larger by 1.5% than that of the battery of Example 1. In Example 2, as shown in FIG. 6C, about one turn of the region having the active material covered portion 22B of the negative electrode only on the inner surface side (surface A) of the negative electrode 22 is provided on the winding end side. A region of the unnecessary negative electrode active material covered portion that does not contribute to the battery reaction is reduced, and the length of the positive electrode active material covered portion 21B is larger than that in Example 1. As a result, it was considered that the initial capacity of the battery of Example 2 could be made larger than that of the battery of Example 1. From the results in Table 1, it was found that when the active material non-covered portion 22C of the negative electrode was provided at the end on the winding start side in the longitudinal direction of the negative electrode 22, and, in addition, at the end on the winding end side in the longitudinal direction, about one turn of the region having the active material covered portion 22B of the negative electrode only on the inner surface side (surface A) of the negative electrode 22 was provided on the winding end side, the battery 1 did not cause the internal short circuit, and a large initial capacity could be obtained.

The present application has been described above according to an embodiment; however, the contents of the present application are not limited to the description herein, and various modifications of the present application can be made.

In Examples and Comparative Examples, for example, the number of the grooves 43 was set to 8, but other numbers may be used. The battery size is 21700, but may be 18650 or any other size.

The positive electrode current collector plate 24 and the negative electrode current collector plate 25 include the fan-shaped portions 31 and 33 having a fan shape, but may have other shapes.

The present application can also be applied to other batteries other than the lithium ion battery and batteries having a shape other than a cylindrical shape (for example, a laminate-type battery, a square-type battery, a coin-type battery, and a button-type battery). In this case, the shape of the “end surface of the electrode winding body” may be not only a cylindrical shape but also an elliptical shape, a flat shape, or the like.

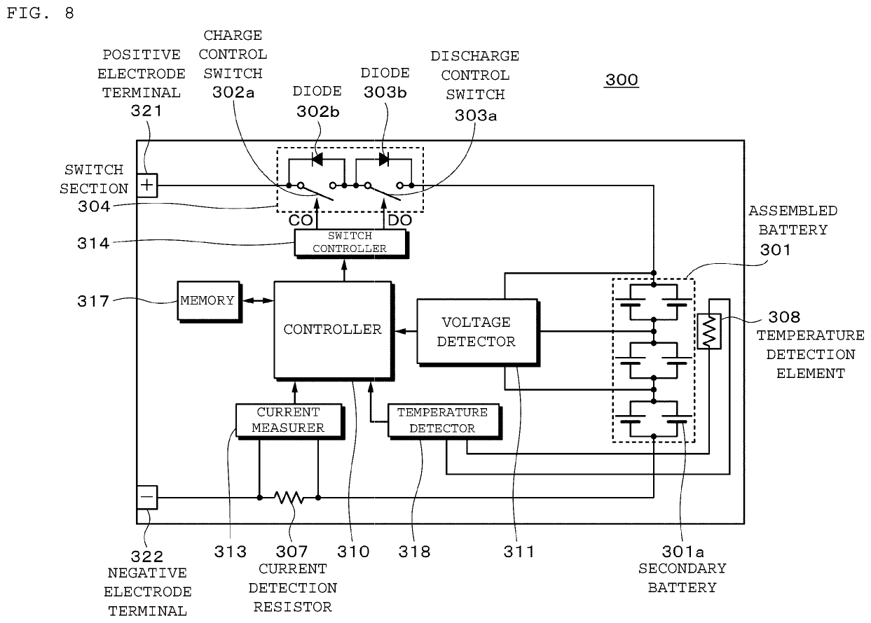

FIG. 8 is a block diagram showing a circuit configuration example in a case where the secondary battery according to the embodiment or Examples is applied to a battery pack 300. The battery pack 300 includes an assembled battery 301, a switch section 304 including a charge control switch 302a and a discharge control switch 303a, a current detection resistor 307, a temperature detection element 308, and a controller 310. The controller 310 can control each device, further perform charge and discharge control at the time of abnormal heat generation, and calculate and correct a remaining capacity of the battery pack 300. A positive electrode terminal 321 and a negative electrode terminal 322 of the battery pack 300 are connected to a charger or an electronic device, and are charged and discharged.

The assembled battery 301 is formed by connecting a plurality of secondary batteries 301a to each other in series and/or in parallel. FIG. 8 shows, as an example, a case where the six secondary batteries 301a are connected to each other in 2 parallel 3 series (2P3S).

The temperature detector 318 is connected to a temperature detection element 308 (for example, a thermistor), measures the temperature of the assembled battery 301 or the battery pack 300, and supplies the measured temperature to the controller 310. A voltage detector 311 measures the voltage of the assembled battery 301 and the respective secondary batteries 301a configuring the assembled battery and performs A/D conversion of this measured voltage to supply the resulting voltage to the controller 310. A current measurer 313 measures the current by using the current detection resistor 307 and supplies this measured current to the controller 310.

A switch controller 314 controls the charge control switch 302a and the discharge control switch 303a of the switch section 304 based on the voltage and the current input from the voltage detector 311 and the current measurer 313. The switch controller 314 prevents overcharge and overdischarge by sending an OFF control signal to the switch section 304 when the voltage of the secondary battery 301a has become equal to or higher than an overcharge detection voltage (for example, 4.20 V±0.05 V) or equal to or lower than an overdischarge detection voltage (2.4 V±0.1 V).

After the charge control switch 302a or the discharge control switch 303a is turned off, charging or discharging can be performed only through a diode 302b or a diode 303b. As these charge/discharge switches, a semiconductor switch such as a MOSFET can be used. In FIG. 8, the switch section 304 is provided on a plus (+) side, but may be provided on a minus (−) side.

The memory 317 includes a RAM and a ROM, and stores and rewrites a value of the battery characteristics calculated by the controller 310, a full charge capacity, the remaining capacity, and the like.

The secondary battery according to an embodiment or Examples described above is mounted on a device such as an electronic device, an electric transportation device, or a power storage device, and can be used for supplying electric power.

Examples of the electronic device include notebook personal computers, smartphones, tablet terminals, PDAs (personal digital assistants), mobile phones, wearable terminals, digital still cameras, electronic books, music players, game machines, hearing aids, power tools, televisions, lighting devices, toys, medical devices, and robots. In addition, electric transportation devices, power storage devices, power tools, and electric unmanned aerial vehicles to be described later can also be included in the electronic device in a broad sense.

Examples of the electric transportation device include electric vehicles (including hybrid vehicles), electric motorcycles, electric assisted bicycles, electric buses, electric carts, automatic guided vehicles (AGV), and railway vehicles. In addition, electric passenger aircrafts and electric unmanned aircrafts for transportation are also included. The secondary battery according to the present invention is used not only as these driving power supplies but also as an auxiliary power supply, a power supply for recovering a regenerated energy, and other power supplies.

Examples of the power storage device include power storage modules for commercial use or household use, and power supplies for electric power storage use for a building such as a house, a building, or an office, or for a power-generating facility.

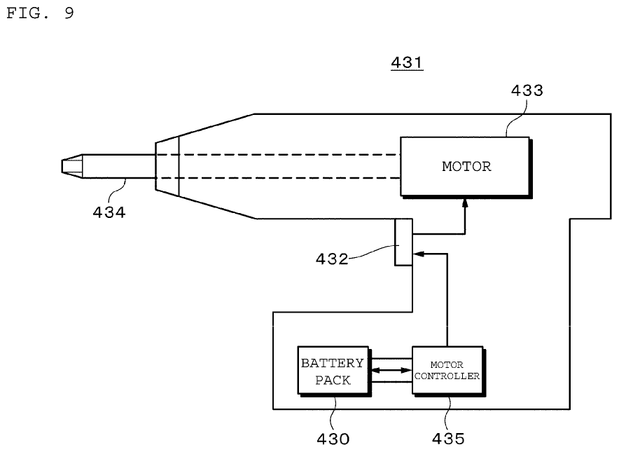

An example of an electric driver as a power tool to which the present application can be applied will be schematically described with reference to FIG. 9. An electric driver 431 is provided with a motor 433 that transmits rotational power to a shaft 434 and a trigger switch 432 operated by a user. A battery pack 430 and a motor controller 435 are housed in a lower housing of a handle of the electric driver 431. The battery pack 430 is built in the electric driver 431 or is detachable.

Each of the battery pack 430 and the motor controller 435 may be provided with a microcomputer (not shown) so that charge/discharge information of the battery pack 430 can be communicated with each other. The motor controller 435 can control operation of the motor 433 and cut off power supply to the motor 433 at the time of abnormality such as overdischarge.

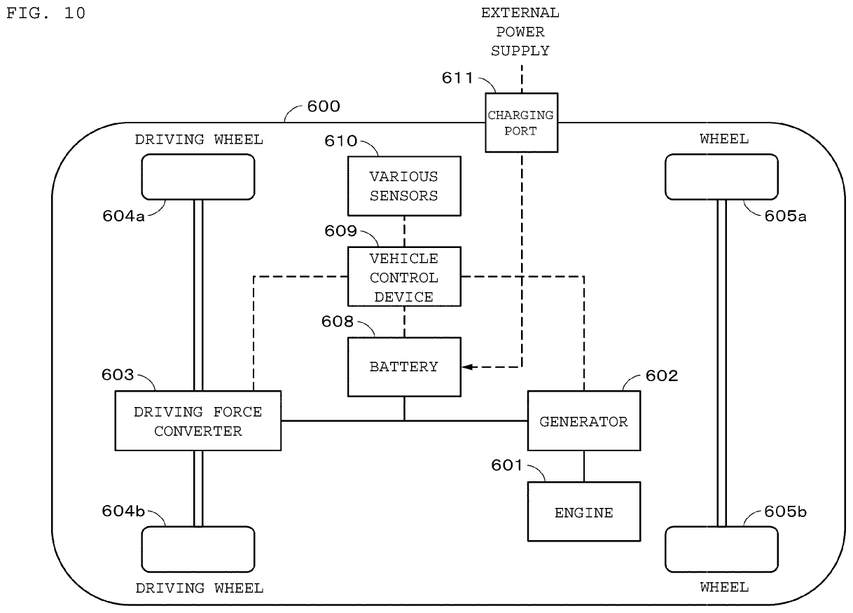

As an example in which the present application is applied to an electric vehicle power storage system, FIG. 10 schematically shows a configuration example of a hybrid vehicle (HV) employing a series hybrid system. The series hybrid system is a car travelling with an electric power driving force converter using electric power generated by a generator powered by an engine or electric power obtained by temporarily storing the generated electric power in a battery.

An engine 601, a generator 602, an electric power driving force converter 603 (DC motor or AC motor, hereinafter, it is simply referred to as the “motor 603”), a driving wheel 604a, a driving wheel 604b, a wheel 605a, a wheel 605b, a battery 608, a vehicle control device 609, various sensors 610, and a charging port 611 are mounted in a hybrid vehicle 600 as described above. As the battery 608, the battery pack 300 or a power storage module on which a plurality of the secondary batteries are mounted can be applied.

The motor 603 is operated by the electric power of the battery 608, and a rotating force of the motor 603 is transmitted to the driving wheels 604a and 604b. The electric power generated by the generator 602 can be stored in the battery 608 by the rotating force generated by the engine 601. The various sensors 610 control an engine speed through the vehicle control device 609, or control an opening degree of a throttle valve (not shown).

When the hybrid vehicle 600 is decelerated by a brake mechanism (not shown), a resistance force during the deceleration is added as a rotating force to the motor 603, and regenerative electric power generated due to this rotating force is stored in the battery 608. The battery 608 can be charged by being connected to an external power supply via the charging port 611 of the hybrid vehicle 600. Such an HV vehicle is referred to as a plug-in hybrid vehicle (PHV or PHEV).

The secondary battery according to the present application can also be applied to a downsized primary battery and used as a power supply of a tire pressure monitoring system (TPMS) built in wheels 604 and 605.

Although a series hybrid vehicle has been described above as an example, the present application is also applicable to a parallel system using an engine and a motor together or a hybrid vehicle in which a series system and a parallel system are combined. In addition, the present invention is also applicable to an electric vehicle (EV or BEV) and a fuel cell vehicle (FCV) that travel only by a drive motor not using an engine.

### DESCRIPTION OF REFERENCE SYMBOLS

1: Lithium ion battery
12: Insulating plate
21: Positive electrode
21A: Positive electrode foil
21B: Positive electrode active material layer
21C: Active material non-covered portion of positive electrode
22: Negative electrode
22A: Negative electrode foil
22B: Negative electrode active material layer
22C: Active material non-covered portion of negative electrode
23: Separator
24: Positive electrode current collector plate
25: Negative electrode current collector plate
26: Through hole
27, 28: Outer edge portion
41, 42: End surface
43: Groove

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode winding body having a structure in which a strip-shaped positive electrode and a strip-shaped negative electrode are stacked with a separator interposed therebetween and wound, a positive electrode collector plate, and a negative electrode collector plate are housed in a battery can,
the positive electrode having a covering portion covered with a positive electrode active material layer and a positive electrode active material non-covered portion on a strip-shaped positive electrode foil,
the negative electrode having a covering portion covered with a negative electrode active material layer and a first negative electrode active material non-covered portion on a strip-shaped negative electrode foil,
the positive electrode active material non-covered portion being joined to the positive electrode current collector plate at one end portion of the electrode winding body,
the first negative electrode active material non-covered portion being joined to the negative electrode current collector plate at the other end portion of the electrode winding body,
the electrode winding body having a flat surface formed by bending any one or both of the positive electrode active material non-covered portion and the first negative electrode active material non-covered portion toward a central axis of the wound structure and overlapping the positive electrode active material non-covered portion and the first negative electrode active material non-covered portion, and a groove formed in the flat surface, and
the negative electrode having a second negative electrode active material non-covered portion at an end portion on a winding start side in a longitudinal direction.

2. The secondary battery according to claim 1, wherein the negative electrode further includes a third negative electrode active material non-covered portion at an end portion on a winding end side in the longitudinal direction.

3. The secondary battery according to claim 2, wherein the negative electrode has, on the winding end side, a region where the negative electrode active material layer is formed only on one main surface.

4. The secondary battery according to claim 3, wherein the region is three-quarters or more of the circumference and five-quarters or less of the circumference of the electrode winding body.

5. An electronic device comprising the secondary battery according to claim 1.

6. A power tool comprising the secondary battery according to claim 1.
